(19) United States
(12) Patent Application Publication
(10) Pub. No.: US 2026/0253427 A1
(43) Pub. Date: Aug. 27, 2026

(54) OTHER VEHICLE BEHAVIOR PREDICTION DEVICE, OTHER VEHICLE BEHAVIOR PREDICTION METHOD, AND NON-TRANSITORY RECORDING MEDIUM

(71) Applicant: TOYOTA JIDOSHA KABUSHIKI KAISHA, Toyota-shi (JP)

(72) Inventor: Masaaki YAMAOKA, Tokyo-to (JP)

(73) Assignee: TOYOTA JIDOSHA KABUSHIKI KAISHA, Toyota-shi (JP)

(21) Appl. No.: 19/407,067

(22) Filed: Dec. 3, 2025

(30) Foreign Application Priority Data
Feb. 21, 2025 (JP) 2025-026922

(51) Int. Cl. G06V 20/58

(52) U.S. Cl. CPC G06V 20/58; G06V 2201/08

(57) ABSTRACT

An other vehicle behavior prediction device predicts whether a driver is present in an other vehicle positioned in surroundings of a host vehicle based on detection results of a surrounding situation sensor for detecting a surrounding situation of the host vehicle, and predicts behavior of the other vehicle based on prediction results of whether the driver is present in the other vehicle and time-series detection results of the other vehicle by the surrounding situation sensor.

### FIELD

The present disclosure relates to an other vehicle behavior prediction device, an other vehicle behavior prediction method, and a non-transitory recording medium.

### BACKGROUND

PTL 1 (JP 2023-508986 A) describes a technology for predicting an intention of a user to share a road with a vehicle.

Though the prediction of the behavior of an other vehicle has been performed in the past, the behavior of the other vehicle has been predicted without considering whether a driver is present in the other vehicle. It is believed that in an other vehicle which is manually driven by a driver, the other vehicle often performs lane change, acceleration, deceleration, or the like even in a situation in which there are no intersections, a situation in which there are no leading vehicles traveling at low speeds or the like, whereas it is believed that in an other vehicle which is autonomously driven without a driver, the other vehicle rarely performs lane change, acceleration, deceleration, or the like in a situation in which there are no intersections, a situation in which there are no leading vehicles traveling at low speeds or the like. Nevertheless, since the behavior of the other vehicle has been predicted without considering whether the driver is present in the other vehicle in the past, the behavior of the other vehicle cannot be predicted with high accuracy.

### SUMMARY

In view of the foregoing, an object of the present disclosure is to provide an other vehicle behavior prediction device, an other vehicle behavior prediction method, and a non-transitory recording medium with which the behavior of the other vehicle can be predicted with high accuracy.

(1) An aspect of the present disclosure provides an other vehicle behavior prediction device including a processor configured to: predict whether a driver is present in an other vehicle positioned in surroundings of a host vehicle based on detection results of a surrounding situation sensor for detecting a surrounding situation of the host vehicle; and predict behavior of the other vehicle based on prediction results of whether the driver is present in the other vehicle and time-series detection results of the other vehicle by the surrounding situation sensor.

(2) In the other vehicle behavior prediction device of aspect (1), behavior of the other vehicle predicted when it is predicted that the driver is present in the other vehicle and behavior of the other vehicle predicted when it is predicted that the driver is not present in the other vehicle may be different.

(3) In the other vehicle behavior prediction device of aspect (1) or (2), the processor may be configured to predict a possibility that the other vehicle performs a lane change based on the prediction results of whether the driver is present in the other vehicle and the time-series detection results of the other vehicle by the surrounding situation sensor by using a prediction model obtained by performing learning using teacher data, which is a data set of time-series detection results of a learning other vehicle from a first time point to a second time point by a learning surrounding situation sensor mounted on a learning host vehicle, and labels indicating information on whether a driver is present in the learning other vehicle and information on whether the learning other vehicle changed lanes at a third time point, which is later than the second time point.

(4) In the other vehicle behavior prediction device of any of aspects (1) to (3), the processor may be configured to predict whether the driver is present in the other vehicle based on behavior of the other vehicle detected by the surrounding situation sensor.

(5) In the other vehicle behavior prediction device of any of aspects (1) to (4), the processor may be configured predict whether the driver is present in the other vehicle based on an image of the other vehicle captured by a camera serving as the surrounding situations sensor.

(6) In the other vehicle behavior prediction device of any of aspects (1) to (5), the processor may be configured predict whether the driver is present in the other vehicle based on information representing whether the driver is present in the other vehicle acquired via wireless communication with an outside of the host vehicle by a wireless communication device serving as the surrounding situation sensor.

(7) An aspect of the present disclosure provides an other vehicle behavior prediction method including: predicting whether a driver is present in an other vehicle positioned in surroundings of a host vehicle based on detection results of a surrounding situation sensor for detecting a surrounding situation of the host vehicle; and predicting behavior of the other vehicle based on prediction results of whether the driver is present in the other vehicle and time-series detection results of the other vehicle by the surrounding situation sensor.

(8) An aspect of the present disclosure provides a non-transitory recording medium having recorded thereon a computer program for causing a processor to perform a process including: predicting whether a driver is present in an other vehicle positioned in surroundings of a host vehicle based on detection results of a surrounding situation sensor for detecting a surrounding situation of the host vehicle; and predicting behavior of the other vehicle based on prediction results of whether the driver is present in the other vehicle and time-series detection results of the other vehicle by the surrounding situation sensor.

According to the present disclosure, the behavior of the other vehicle can be predicted with high accuracy.

### BRIEF DESCRIPTION OF DRAWINGS

FIG. 1 is a view showing an example of a host vehicle 1 to which an other vehicle behavior prediction device 15 of a first embodiment is applied.

FIG. 2A is a view showing an example of prediction results of behavior of an other vehicle OV by an other vehicle behavior prediction unit 3D when an other vehicle driver prediction unit 3C predicts that a driver is present in the other vehicle OV, and the like.

FIG. 2B is a view showing an example of the prediction results of the behavior of the other vehicle OV by the other vehicle behavior prediction unit 3D when the other vehicle driver prediction unit 3C predicts that a driver is not present in the other vehicle OV, and the like.

FIG. 3 is a flowchart for explaining an example of a process performed by a processor 153 of the other vehicle behavior prediction device 15 of the first embodiment.

FIG. 4A is a view showing an example of the prediction results of the behavior of the other vehicle OV by the other vehicle behavior prediction unit 3D when the other vehicle driver prediction unit 3C predicts that a driver is present in the other vehicle OV, and the like.

FIG. 4B is a view showing an example of the prediction results of the behavior of the other vehicle OV by the other vehicle behavior prediction unit 3D when the other vehicle driver

prediction unit 3C predicts that a driver is not present in the other vehicle OV, and the like.

### DESCRIPTION OF EMBODIMENTS

The embodiments of the other vehicle behavior prediction device, the other vehicle behavior prediction method, and the non-transitory recording medium of the present disclosure will be described below with reference to the drawings.

### First Embodiment

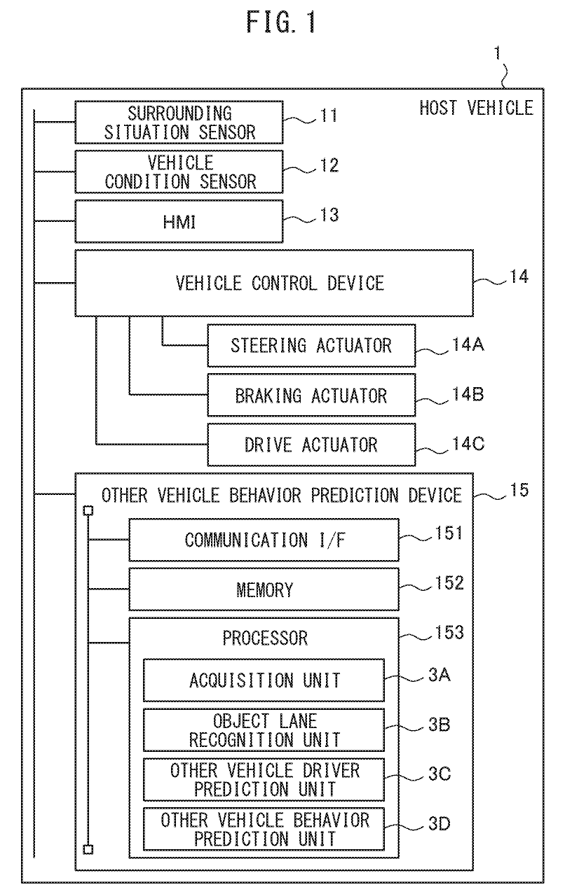

FIG. 1 is a view showing an example of a host vehicle 1 to which an other vehicle behavior prediction device 15 of a first embodiment is applied.

In the example shown in FIG. 1, the host vehicle 1 includes a surrounding situation sensor 11, a vehicle condition sensor 12, a human machine interface (HMI) 13, a vehicle control device 14, a steering actuator 14A, a braking actuator 14B, a drive actuator 14C, and the other vehicle behavior prediction device 15.

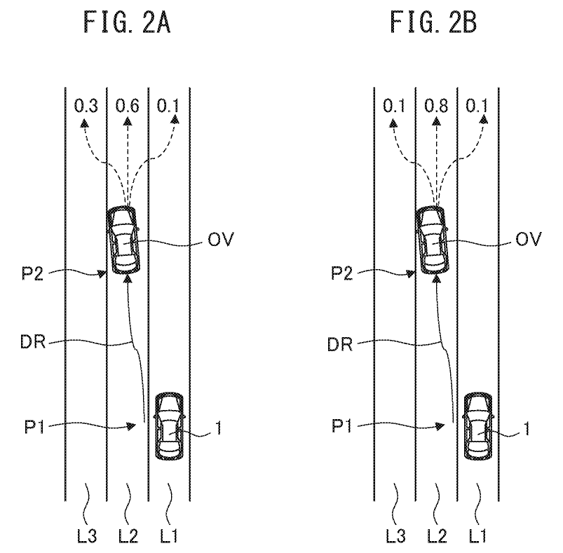

The surrounding situation sensor 11 detects a surrounding situation of the host vehicle 1 (for example, other vehicle OV (refer to FIGS. 2A and 2B) positioned in surroundings of the host vehicle 1, obstacles positioned in the surroundings of the host vehicle 1, etc.), and transmits detection results of the surrounding situation of the host vehicle 1 to the vehicle control device 14 and the other vehicle behavior prediction device 15. The surrounding situation sensor 11 includes, for example, a camera, a LiDAR (Light Detection And Ranging), a radar, a wireless communication device for acquiring information representing a situation outside the host vehicle 1 from outside the host vehicle 1 via wireless communication, etc.

The vehicle condition sensor 12 performs detection of the condition of the host vehicle 1, measurement of the position of the host vehicle 1 and the like, and transmits the detection results of the condition of the host vehicle 1, the measurement results of the position of the host vehicle 1 and the like to the vehicle control device 14 and the other vehicle behavior prediction device 15. The vehicle condition sensor 12 includes, for example, a vehicle speed sensor, an acceleration sensor, a yaw rate sensor, a gyro sensor, a GPS (Global Positioning System) receiver, etc.

The HMI 13 has the function of accepting various operations by the driver of the host vehicle 1 and the like, and transmits signals representing the operations by the driver of the host vehicle 1 to the vehicle control device 14.

The vehicle control device 14 controls the steering actuator 14A, the braking actuator 14B, and the drive actuator 14C based on, for example, information (data, signals) and the like transmitted from the surrounding situation sensor 11, the vehicle condition sensor 12, and the HMI 13. In detail, the vehicle control device 14 has an autonomous driving function for controlling the steering actuator 14A, the braking actuator 14B, and the drive actuator 14C to cause the host vehicle 1 to drive autonomously without the need for operation by the driver of the host vehicle 1. Specifically, the vehicle control device 14 generates a driving plan for the host vehicle 1 to reach its destination based on, for example, map information, position information of the host vehicle 1, information representing the destination of the host vehicle 1, etc. Furthermore, the vehicle control device 14 causes the host vehicle 1 to drive autonomously in accordance with the driving plan. In detail, the vehicle control device 14 causes the host vehicle 1 to drive autonomously while revising the driving plan to avoid collisions between the host vehicle 1 and the other vehicle OV (refer to FIGS. 2A and 2B), etc., based on the detection results of the surrounding situation sensor 11, prediction results of the behavior of the other vehicle OV by the other vehicle behavior prediction device 15, which will be described later, etc.

The other vehicle behavior prediction device 15 is constituted by a microcomputer including a communication interface (I/F) 151, a memory 152, and a processor 153.

The communication interface 151 includes an interface circuit for connecting the other vehicle behavior prediction device 15 to the surrounding situation sensor 11, the vehicle condition sensor 12, the HMI 13, and the vehicle control device 14. The memory 152 stores a program used in a process performed by the processor 153 and various data. The processor 153 has a function as an acquisition unit 3A, a function as an object lane recognition unit 3B, a function as an other vehicle driver prediction unit 3C, and a function as an other vehicle behavior prediction unit 3D.

The acquisition unit 3A acquires the detection results of the surrounding situation of the host vehicle 1 and the measurement results of the position of the host vehicle 1.

The object lane recognition unit 3B performs recognition of an object such as the other vehicle OV (refer to FIGS. 2A and 2B) or the like positioned in the surroundings of the host vehicle 1 and recognition of lanes positioned in the surroundings of the host vehicle 1 based on the detection results of the surrounding situation of the host vehicle 1 acquired by the acquisition unit 3A.

The other vehicle driver prediction unit 3C predicts whether a driver is present in the other vehicle OV positioned in the surroundings of the host vehicle 1, based on the detection results (sensor data from the surrounding situation sensor 11) of the surrounding situation of the host vehicle 1 acquired by the acquisition unit 3A.

In the example shown in FIG. 1, the other vehicle driver prediction unit 3C predicts whether the driver is present in the other vehicle OV based on the behavior of the other vehicle OV (time-series sensor data of the surrounding situation sensor 11) detected by, for example, the camera or the like serving as the surrounding situation sensor 11. Specifically, when the surrounding situation sensor 11 detects human-specific driving behavior, such as sudden acceleration, sudden braking, frequent lane changes, etc., of the other vehicle OV, the other vehicle driver prediction unit 3C predicts that the driver is present in the other vehicle OV.

In another example, the other vehicle driver prediction unit 3C predicts whether the driver is present in the other vehicle OV (refer to FIGS. 2A and 2B) based on an image of the other vehicle OV captured by the camera serving as the surrounding situation sensor 11. For example, when the driver of the other vehicle OV is included in the image including a rearview mirror or a side mirror of the other vehicle OV captured by the camera serving as the surrounding situation sensor 11 (specifically, when the driver of the other vehicle OV is reflected in the rearview mirror or the side mirror of the other vehicle OV), the other vehicle driver prediction unit 3C predicts that the driver is present in the other vehicle OV.

In yet another example, the other vehicle driver prediction unit 3C predicts whether the driver is present in the other vehicle OV based on information representing whether the driver is present in the other vehicle OV acquired from outside the host vehicle 1 by a wireless communication device serving as the surrounding situation sensor 11. Specifically, the wireless communication device serving as the surrounding situation sensor 11 acquires the information representing whether the driver is present in the other vehicle OV by performing, for example, V2I (Vehicle-to-Roadside-Infrastructure) communication or V2V (Vehicle-to-Vehicle) communication, and the other vehicle driver prediction unit 3C predicts whether the driver is present in the other vehicle OV based on the information.

In the example shown in FIG. 1, the other vehicle behavior prediction unit 3D predicts the behavior of the other vehicle OV based on the prediction results of whether the driver is present in the other vehicle OV by the other vehicle driver prediction unit 3C and time-series detection results DR (refer to FIGS. 2A and 2B) of the other vehicle OV by the surrounding situation sensor 11.

FIGS. 2A and 2B are views showing examples of the time-series detection results DR of the other vehicle OV by the surrounding situation sensor 11 and the prediction results of the behavior of the other vehicle OV by the other vehicle behavior prediction unit 3D. In detail, FIG. 2A shows an example of the prediction results of the behavior of the other vehicle OV by the other vehicle behavior prediction unit 3D when the other vehicle driver prediction unit 3C predicts that the driver is present in the other vehicle OV, and FIG. 2B shows an example of the prediction results of the behavior of the other vehicle OV by the other vehicle behavior prediction unit 3D when the other vehicle driver prediction unit 3C predicts that the driver is not present in the other vehicle OV.

In the example shown in FIG. 2A, the host vehicle 1 is traveling in a lane L1, and the other vehicle OV is traveling in a lane L2. Specifically, the other vehicle OV is passing through a position P2 of the lane L2. The other vehicle behavior prediction device 15 predicts the behavior of the other vehicle OV after the time point shown in FIG. 2A to enable the host vehicle 1 to travel safely without a collision between the host vehicle 1 and the other vehicle OV, or the like.

Specifically, in the example shown in FIG. 2A, the other vehicle driver prediction unit 3C predicts that the driver is present in the other vehicle OV (specifically, there is a possibility that the other vehicle OV is being manually driven) based on the detection results of the surrounding situation sensor 11.

The other vehicle behavior prediction unit 3D predicts the behavior of the other vehicle OV based on the prediction results that the driver is present in the other vehicle OV by the other vehicle driver prediction unit 3C and the time-series detection results DR of the other vehicle OV (more specifically, the position trajectory of the other vehicle OV from the time point when the other vehicle OV passes a position P1 to the time point when the other vehicle OV passes the position P2) by the surrounding situation sensor 11.

In detail, the other vehicle behavior prediction unit 3D predicts that the possibility of the other vehicle OV changing lanes from the lane L2 to a lane L3 is 30%, predicts that the possibility of the other vehicle OV continuing to travel in the lane L2 without changing lanes is 60%, and predicts that the possibility of the other vehicle OV changing lanes from the lane L2 to the lane L1 is 10%.

In the example shown in FIG. 2B, the host vehicle 1 is traveling in the lane L1, and the other vehicle OV is traveling in the lane L2. Specifically, the other vehicle OV is passing through the position P2 of the lane L2. The other vehicle behavior prediction device 15 predicts the behavior of the other vehicle OV after the time point shown in FIG. 2B to enable the host vehicle 1 to travel safely without the collision between the host vehicle 1 and the other vehicle OV, or the like.

Specifically, in the example shown in FIG. 2B, the other vehicle driver prediction unit 3C predicts that the driver is not present in the other vehicle OV (i.e., the other vehicle OV is driving autonomously) based on the detection results of the surrounding situation sensor 11.

The other vehicle behavior prediction unit 3D predicts the behavior of the other vehicle OV based on the prediction results that the driver is not present in the other vehicle OV by the other vehicle driver prediction unit 3C and the time-series detection results DR of the other vehicle OV (more specifically, the position trajectory of the other vehicle OV from the time point when the other vehicle OV passes the position P1 to the time point when the other vehicle OV passes the position P2) by the surrounding situation sensor 11.

In detail, the other vehicle behavior prediction unit 3D predicts that the possibility of the other vehicle OV changing lanes from the lane L2 to the lane L3 is 10%, predicts that the possibility of the other vehicle OV continuing to travel in the lane L2 without changing lanes is 80%, and predicts that the possibility of the other vehicle OV changing lanes from the lane L2 to the lane L1 is 10%.

In the examples shown in FIGS. 2A and 2B, the behavior (the possibility of the other vehicle OV changing lanes from the lane L2 to the lane L3 is 30%, the possibility of the other vehicle OV continuing to travel in the lane L2 without changing lanes is 60%, and the possibility of the other vehicle OV changing lanes from the lane L2 to the lane L1 is 10%) of the other vehicle OV predicted by the other vehicle behavior prediction unit 3D when it is predicted that the driver is present in the other vehicle OV by the other vehicle driver prediction unit 3C and the behavior (the possibility of the other vehicle OV changing lanes from the lane L2 to the lane L3 is 10%, the possibility of the other vehicle OV continuing to travel in the lane L2 without changing lanes is 80%, and the possibility of the other vehicle OV changing lanes from the lane L2 to the lane L1 is 10%) of the other vehicle OV predicted by the other vehicle behavior prediction unit 3D when it is predicted that the driver is not present in the other vehicle OV by the other vehicle driver prediction unit 3C are different.

In the examples shown in FIGS. 2A and 2B, though the position trajectory of the other vehicle OV from the time point when the other vehicle OV passes the position P1 to the time point when the other vehicle OV passes the position P2 is used as the time-series detection results DR of the other vehicle OV by the surrounding situation sensor 11, in another example, the detection results of the orientation of the other vehicle OV from the time point when the other vehicle OV passes the position P1 to the time point when the other vehicle OV passes the position P2 may be used as the time-series detection results DR of the other vehicle OV by the surrounding situation sensor 11.

In yet another example, as the time-series detection results DR of the other vehicle OV by the surrounding situation sensor 11, the detection results such as speed, acceleration, braking pattern, etc., of the other vehicle OV from the time point when the other vehicle OV passes the position P1 to the time point when the other vehicle OV passes the position P2 may be used.

In the example shown in FIG. 1, the other vehicle behavior prediction unit 3D predicts the possibility that the other vehicle OV performs a lane change based on the prediction results of whether the driver is present in the other vehicle OV by the other vehicle driver prediction unit 3C and the time-series detection results of the other vehicle OV by the surrounding situation sensor 11 by using a prediction model obtained by performing learning using teacher data, which is a data set of time-series detection results of a learning other vehicle (not shown) from a first time point to a second time point by a learning surrounding situation sensor (not shown) mounted on a learning host vehicle (not shown), and labels indicating information on whether the driver is present in the learning other vehicle and information on whether the learning other vehicle changed lanes at a third time point, which is later than the second time point.

In another example, the other vehicle behavior prediction unit 3D may predict the possibility that the other vehicle OV performs the lane change based on the prediction results of whether the driver is present in the other vehicle OV by the other vehicle driver prediction unit 3C and the time-series detection results of the other vehicle OV by the surrounding situation sensor 11 by using a prediction model obtained by a method different from the example shown in FIG. 1.

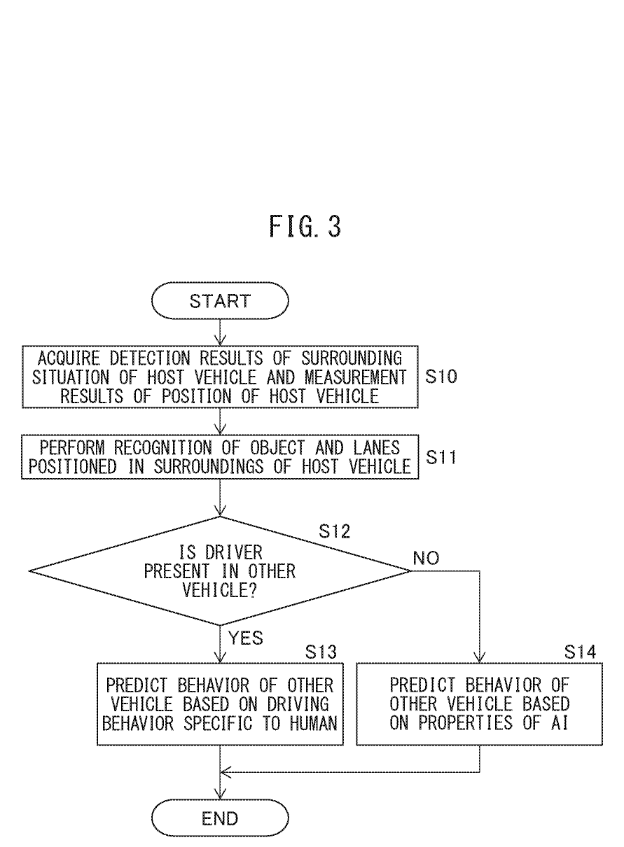

FIG. 3 is a flowchart for explaining an example of the process performed by the processor 153 of the other vehicle behavior prediction device 15 of the first embodiment.

In the example shown in FIG. 3, at step S10, the acquisition unit 3A acquires the detection results of the surrounding situation of the host vehicle 1 and the measurement results of the position of the host vehicle 1.

At step S11, the object lane recognition unit 3B performs the recognition of the object such as the other vehicle OV positioned in the surroundings of the host vehicle 1 and the recognition of the lanes positioned in the surroundings of the host vehicle 1 based on the detection results of the surrounding situation of the host vehicle 1 acquired at step S10.

At step S12, the other vehicle driver prediction unit 3C predicts whether the driver is present in the other vehicle OV positioned in the surroundings of the host vehicle 1, based on the detection results of the surrounding situation of the host vehicle 1 acquired at step S10. In the case of YES, the process proceeds to step S13, and in the case of NO, the process proceeds to step S14.

At step S13, the other vehicle behavior prediction unit 3D predicts the behavior of the other vehicle OV based on the time-series detection results DR of the other vehicle OV by the surrounding situation sensor 11 and the driving behavior (irregular driving behavior based on emotion, attention, experience, etc. of the human) specific to the human (the driver of the other vehicle OV).

At step S14, the other vehicle behavior prediction unit 3D predicts the behavior (regular and safe driving behavior according to a programmed algorithm) of the other vehicle OV based on the time-series detection results DR of the other vehicle OV by the surrounding situation sensor 11 and properties (algorithm) of the AI (Artificial Intelligence) applied to the other vehicle OV (autonomous vehicle).

As described above, in the other vehicle behavior prediction device 15 of the first embodiment, unlike the prior art, in which the behavior of the other vehicle OV is predicted on the assumption that the other vehicle OV is being driven manually by the driver of the other vehicle OV, when the other vehicle OV is an autonomously driven vehicle, the behavior of the autonomously driven vehicle (other vehicle OV) to which prediction based on human reactions and driving tendencies does not apply can be predicted with high accuracy. As a result, the safety and reliability of autonomous driving of the host vehicle 1 can be improved.

### Second Embodiment

The host vehicle 1 to which the other vehicle behavior prediction device 15 of a second embodiment is applied is configured in the same manner as the host vehicle 1 to which the other vehicle behavior prediction device 15 of the first embodiment is applied, except for the points described below.

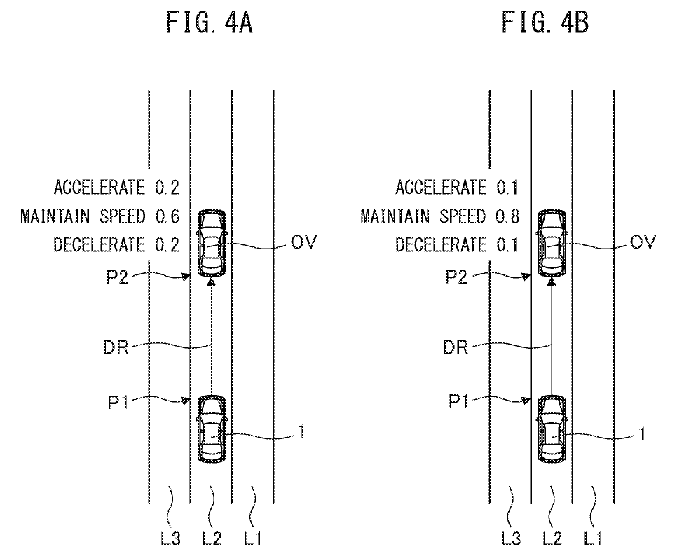

FIGS. 4A and 4B are views showing examples of the time-series detection results DR of the other vehicle OV by the surrounding situation sensor 11 and the prediction results of the behavior of the other vehicle OV by the other vehicle behavior prediction unit 3D of the other vehicle behavior prediction device 15 of the second embodiment. In detail, FIG. 4A shows an example of the prediction results of the behavior of the other vehicle OV by the other vehicle behavior prediction unit 3D when the other vehicle driver prediction unit 3C predicts that the driver is present in the other vehicle OV, and FIG. 4B shows an example of the prediction results of the behavior of the other vehicle OV by the other vehicle behavior prediction unit 3D when the other vehicle driver prediction unit 3C predicts that the driver is not present in the other vehicle OV.

In the example shown in FIG. 4A, the host vehicle 1 is traveling in the lane L2, and the other vehicle OV is traveling in front of the host vehicle 1. Specifically, the other vehicle OV is passing through the position P2 of the lane L2. The other vehicle behavior prediction device 15 predicts the behavior of the other vehicle OV after the time point shown in FIG. 4A to enable the host vehicle 1 to travel safely without the collision between the host vehicle 1 and the other vehicle OV, or the like.

Specifically, in the example shown in FIG. 4A, the other vehicle driver prediction unit 3C predicts that the driver is present in the other vehicle OV (i.e., there is a possibility that the other vehicle OV is being manually driven) based on the detection results of the surrounding situation sensor 11.

The other vehicle behavior prediction unit 3D predicts the behavior of the other vehicle OV based on the prediction results that the driver is present in the other vehicle OV by the other vehicle driver prediction unit 3C and the time-series detection results DR of the other vehicle OV (more specifically, the speed, acceleration, braking pattern, etc., of the other vehicle OV from the time point when the other vehicle OV passes the position P1 to the time point when the other vehicle OV passes the position P2) by the surrounding situation sensor 11.

In detail, the other vehicle behavior prediction unit 3D predicts that the possibility of the other vehicle OV accelerating is 20%, predicts that the possibility of the other vehicle OV continuing to travel at a constant speed without accelerating or decelerating is 60%, and predicts that the possibility of the other vehicle OV decelerating is 20%.

In the example shown in FIG. 4B, the host vehicle 1 is traveling in the lane L2, and the other vehicle OV is traveling in front of the host vehicle 1. Specifically, the other vehicle OV is passing through the position P2 of the lane L2. The other vehicle behavior prediction device 15 predicts the behavior of the other vehicle OV after the time point shown in FIG. 4B to enable the host vehicle 1 to travel safely without the collision between the host vehicle 1 and the other vehicle OV, or the like.

Specifically, in the example shown in FIG. 4B, the other vehicle driver prediction unit 3C predicts that the driver is not present in the other vehicle OV (i.e., the other vehicle OV is driving autonomously) based on the detection results of the surrounding situation sensor 11.

The other vehicle behavior prediction unit 3D predicts the behavior of the other vehicle OV based on the prediction results that the driver is not present in the other vehicle OV by the other vehicle driver prediction unit 3C and the time-series detection results DR of the other vehicle OV (more specifically, the speed, acceleration, braking pattern, etc., of the other vehicle OV from the time point when the other vehicle OV passes the position P1 to the time point when the other vehicle OV passes the position P2) by the surrounding situation sensor 11.

In detail, the other vehicle behavior prediction unit 3D predicts that the possibility of the other vehicle OV accelerating is 10%, predicts that the possibility of the other vehicle OV continuing to travel at a constant speed without accelerating or decelerating is 80%, and predicts that the possibility of the other vehicle OV decelerating is 10%.

In an example of the host vehicle 1 to which the other vehicle behavior prediction device 15 of the second embodiment is applied, the other vehicle behavior prediction unit 3D predicts the possibility that the other vehicle OV accelerates or decelerates based on the prediction results of whether the driver is present in the other vehicle OV by the other vehicle driver prediction unit 3C and the time-series detection results of the other vehicle OV by the surrounding situation sensor 11 by using a prediction model obtained by performing learning using teacher data, which is a data set of time-series detection results of a learning other vehicle (not shown) from a first time point to a second time point by a learning surrounding situation sensor (not shown) mounted on a learning host vehicle (not shown), and labels indicating information on whether the driver is present in the learning other vehicle and information on whether the learning other vehicle accelerated or decelerated at a third time point, which is later than the second time point.

In another example, the other vehicle behavior prediction unit 3D may predict the possibility that the other vehicle OV accelerates or decelerates based on the prediction results of whether the driver is present in the other vehicle OV by the other vehicle driver prediction unit 3C and the time-series detection results of the other vehicle OV by the surrounding situation sensor 11 by using a prediction model obtained by a method different from the example described above.

### Third Embodiment

The host vehicle 1 to which the other vehicle behavior prediction device 15 of a third embodiment is applied is configured in the same manner as the host vehicle 1 to which the other vehicle behavior prediction device 15 of the first or second embodiment is applied, except for the points described below.

As described above, in the host vehicle 1 to which the other vehicle behavior prediction device 15 of the first embodiment is applied, the vehicle control device 14 has the automatic driving function for controlling the steering actuator 14A, the braking actuator 14B, and the drive actuator 14C to cause the host vehicle 1 to drive autonomously without the need for operation by the driver of the host vehicle 1. Specifically, the vehicle control device 14 generates the driving plan for the host vehicle 1 to reach its destination based on, for example, the map information, position information of the host vehicle 1, the information representing the destination of the host vehicle 1, etc. Furthermore, the vehicle control device 14 causes the host vehicle 1 to drive autonomously in accordance with the driving plan. In detail, the vehicle control device 14 causes the host vehicle 1 to drive autonomously while revising the driving plan to avoid collisions between the host vehicle 1 and the other vehicle OV (refer to FIGS. 2A and 2B), etc., based on the detection results of the surrounding situation sensor 11, the prediction results of the behavior of the other vehicle OV by the other vehicle behavior prediction device 15, etc.

In contrast, in the host vehicle 1 to which the other vehicle behavior prediction device 15 of the third embodiment is applied, the vehicle control device 14 has a driving assistance function. Specifically, when it is predicted that it will be necessary to avoid the collision between the host vehicle 1 and the other vehicle OV (refer to FIG. 2A and FIG. 2B) based on the detection results of the surrounding situation sensor 11 and the prediction results of the behavior of the other vehicle OV by the other vehicle behavior prediction device 15 and the like, the vehicle control device 14 causes the HMI 13 to output an alert indicating as such.

Though the embodiments of the other vehicle behavior prediction device, other vehicle behavior prediction method, and non-transitory recording medium of the present disclosure have been described with reference to the drawings as described above, the other vehicle behavior prediction device, other vehicle behavior prediction method, and non-transitory recording medium

of the present disclosure are not limited to the embodiments described above, and appropriate modifications can be made without departing from the spirit of the present disclosure. The configurations of the examples of the embodiments described above may be appropriately combined. Though the process performed by the other vehicle behavior prediction device 15 in each of the examples of the embodiments described above has been described as software process performed by executing the program, the process performed by the other vehicle behavior prediction device 15 may also be the process performed by hardware. Alternatively, the process performed by the other vehicle behavior prediction device 15 may also be the process which combines both software and hardware. Furthermore, the program stored in the memory 152 of the other vehicle behavior prediction device 15 (the program for realizing the functions of the processor 153 of the other vehicle behavior prediction device 15) may be recorded, provided, distributed, etc., on a computer-readable storage medium (non-transitory recording medium) such as a semiconductor memory, a magnetic recording medium, an optical recording medium, etc.

1. An other vehicle behavior prediction device comprising a processor configured to:
predict whether a driver is present in an other vehicle positioned in surroundings of a host vehicle based on detection results of a surrounding situation sensor for detecting a surrounding situation of the host vehicle; and
predict behavior of the other vehicle based on prediction results of whether the driver is present in the other vehicle and time-series detection results of the other vehicle by the surrounding situation sensor.

2. The other vehicle behavior prediction device according to claim 1, wherein behavior of the other vehicle predicted when it is predicted that the driver is present in the other vehicle and behavior of the other vehicle predicted when it is predicted that the driver is not present in the other vehicle are different.

3. The other vehicle behavior prediction device according to claim 1, wherein the processor is configured to predict a possibility that the other vehicle performs a lane change based on the prediction results of whether the driver is present in the other vehicle and the time-series detection results of the other vehicle by the surrounding situation sensor by using a prediction model obtained by performing learning using teacher data, which is a data set of time-series detection results of a learning other vehicle from a first time point to a second time point by a learning surrounding situation sensor mounted on a learning host vehicle, and labels indicating information on whether a driver is present in the learning other vehicle and information on whether the learning other vehicle changed lanes at a third time point, which is later than the second time point.

4. The other vehicle behavior prediction device according to claim 1, wherein the processor is configured to predict whether the driver is present in the other vehicle based on behavior of the other vehicle detected by the surrounding situation sensor.

5. The other vehicle behavior prediction device according to claim 1, wherein the processor is configured predict whether the driver is present in the other vehicle based on an image of the other vehicle captured by a camera serving as the surrounding situations sensor.

6. The other vehicle behavior prediction device according to claim 1, wherein the processor is configured predict whether the driver is present in the other vehicle based on information representing whether the driver is present in the other vehicle acquired via wireless communication with an outside of the host vehicle by a wireless communication device serving as the surrounding situation sensor.

7. An other vehicle behavior prediction method comprising:
predicting whether a driver is present in an other vehicle positioned in surroundings of a host vehicle based on detection results of a surrounding situation sensor for detecting a surrounding situation of the host vehicle; and
predicting behavior of the other vehicle based on prediction results of whether the driver is present in the other vehicle and time-series detection results of the other vehicle by the surrounding situation sensor.

8. A non-transitory recording medium having recorded thereon a computer program for causing a processor to perform a process comprising:
predicting whether a driver is present in an other vehicle positioned in surroundings of a host vehicle based on detection results of a surrounding situation sensor for detecting a surrounding situation of the host vehicle; and
predicting behavior of the other vehicle based on prediction results of whether the driver is present in the other vehicle and time-series detection results of the other vehicle by the surrounding situation sensor.
